(19) United States
(12) Patent Application Publication
(10) Pub. No.: US 2026/0356332 A1
(43) Pub. Date: Nov. 12, 2026

(54) BRAKING SUPPORT METHOD FOR A MOTORCYCLE

(71) Applicant: Robert Bosch GmbH, Stuttgart (DE)

(72) Inventors: Felix Hellmann, Markgroeningen-Hardthof (DE); Mathias Koetter, Osnabrueck (DE); Michael Schoenherr, Renningen-Malmsheim (DE); Ralph Schock, Backnang (DE)

(21) Appl. No.: 19/138,498

(22) PCT Filed: Mar. 6, 2024
(86) PCT No.: PCT/EP2024/055823

§ 371 Date: Jun. 12, 2025

(30) Foreign Application Priority Data
Mar. 10, 2023 (DE) 10 2023 202 168.4

(51) Int. Cl. B60T 8/17

(52) U.S. Cl. CPC B60T 8/1706; B60T 2201/03; B60T 2210/32; B60T 2220/04

(57) ABSTRACT

A braking support method for a motorcycle. In response to detection of a collision hazard for the motorcycle using a sensor system of the motorcycle and detection of a braking request from a rider of the motorcycle, a deceleration demand for a brake system of the motorcycle is increased to a predefined first deceleration value. In response to detection of a subsequent further squeezing by the rider, the deceleration demand is increased to a predefined second deceleration value.

### FIELD

The present invention relates to a braking support method for a motorcycle, to a corresponding control unit, and to a corresponding computer program product.

### BACKGROUND INFORMATION

A motorcycle is an unstable system and is kept in a controllable range by a rider by constant corrections. The motorcycle may detect an imminent collision hazard via a sensor system and automatically initiate a braking operation. Because the braking operation was not initiated by the rider himself, he is surprised by it and is not prepared to stabilize the motorcycle by appropriate corrections. Therefore, an automatically triggered braking operation must have only limited braking effect. The braking effect is allowed to be only so high that a rider can still make the necessary corrections and thus remains in the controllable range and can prevent a fall.

### SUMMARY

The present invention provides a braking support method for a motorcycle, a corresponding control unit, and a corresponding computer program product. Advantageous embodiments, developments and improvements of the present invention are disclosed herein.

An inattentive rider is surprised by a braking operation not demanded by the rider himself. An attentive rider, however, is not surprised and will attempt to take control of the braking operation. The present invention may keep the braking operation safely controllable for the rider by providing braking support only when the rider is attentive. The attentiveness is detected on the basis of inputs from the rider at operating elements of a brake system of the motorcycle.

A sensor system of the motorcycle may detect imminent collisions with high probability. However, in the approach presented here, the braking support is not provided until the rider indicates, by actuating a brake of the motorcycle, that he has recognized the hazardous situation. First, limited braking support is provided which even an inattentive rider can control, if the actuation of the brake was involuntary.

If the rider is attentive, however, he generally can safely control a significantly higher braking effect.

According to an example embodiment of the present invention, after the first braking support has been provided, it is again checked whether the rider is attentive. If the rider is attentive, the braking support is increased. The attentiveness is detected as a result of the rider's use of a brake lever and/or a brake pedal of the motorcycle to build up more primary brake pressure than at the beginning when the hazardous situation is detected, i.e., the rider's further squeezing.

By the approach presented here, the motorcycle can be braked significantly more intensely than without the increase in the braking support. Nevertheless, the motorcycle is safely controlled because the rider's braking request is constantly monitored.

According to an example embodiment of the present invention, a braking support method for a motorcycle is provided, wherein, in response to detection of a collision hazard for the motorcycle using a sensor system of the motorcycle and detection of a braking request from a rider of the motorcycle, a deceleration demand for a brake system of the motorcycle is increased to a predefined first deceleration value, wherein, in response to detection of a subsequent further squeezing and/or further stepping by the rider, the deceleration demand is increased to a predefined second deceleration value.

Ideas for embodiments of the present invention may, inter alia, be regarded as being based on the concepts and findings described below.

A collision hazard may be sensed, for example, by a predictive sensor of the motorcycle. The sensor may be, for example, a radar sensor. The collision hazard may be detected, for example, when, without braking intervention, the motorcycle would drive into an object driving in front. Since the detection by the sensor system may not be completely unequivocal, according to an example embodiment of the present invention, the rider of the motorcycle is used essentially as a human sensor for confirming the collision hazard. The rider confirms the detected collision hazard by operating a brake operating element of a brake system of the motorcycle, i.e., a brake lever on the handlebars of the motorcycle and/or a brake pedal on footrests of the motorcycle. If the rider confirms the collision hazard, the brake system is controlled such that it builds up additional support brake pressure beyond a brake pressure generated by the rider at the brake operating element. The support brake pressure is provided in levels. A first level is parameterized such that even an unprepared rider can still safely control the motorcycle and, for example, can still swerve. A first deceleration value represents the first level.

However, if the rider demands further braking support beyond the first level of the braking support by squeezing the brake operating element further, i.e., generating more brake pressure, this is considered a sure indication that the rider really wants to brake more intensely. Then the braking support is raised to a higher, second level and a braking distance of the motorcycle can be significantly shortened. The second level is represented by the second deceleration value. The second deceleration value is greater than the first deceleration value.

According to an example embodiment of the present invention, the braking request may be detected when the brake pressure demanded via the at least one brake operating element of the motorcycle is greater than a threshold value. The threshold value for triggering the braking support may be low enough that the rider can exceed it without exertion.

The braking request may be detected when the brake pressure is constant within a predefined hysteresis range around the threshold value or increases. Because the rider is a human being, he may reduce the brake pressure slightly, for example when repositioning his hands on the handlebars, and only thereafter increase it again, or vice versa. However, the rider will not completely reduce the brake pressure in a true hazardous situation.

The further squeezing may be detected when the demanded brake pressure is greater than a predefined further-squeezing value. The further-squeezing value may be so high that it will not be exceeded inadvertently. However, the further-squeezing value may be low enough that an average rider also surely has enough hand force to exceed the further-squeezing value.

According to an example embodiment of the present invention, in response to detection of a subsequent second further squeezing, the deceleration demand may be increased to a third deceleration value. If, after the increase in the deceleration demand in response to the first further squeezing, the rider squeezes further once more, i.e., presses the brake lever or the brake pedal even more, it may be assumed that the rider wants to call up the maximum deceleration that is possible at the moment. The third deceleration value may be within an ABS control range. Thus, the ABS can respond to decelerate the motorcycle as much as possible.

The third deceleration value may be set using the demanded brake pressure during the second further squeezing and a predefined increase factor. The third deceleration value may also be dynamic. The rider may influence the third deceleration value via his braking behavior. The brake pressure pressed at the brake lever or brake pedal may be multiplied by the increase factor.

The second further squeezing may be detected when the demanded brake pressure is greater than a predefined second further-squeezing value. The second further-squeezing value may be higher than the first further-squeezing value. The second further-squeezing value may be so high that it will be exceeded only if an extremely acute collision hazard is really detected by the rider. Then the rider will operate the brake operating element basically with high force.

The method of the present invention is preferably computer-implemented and can be implemented in software or hardware, for example, or in a mixed form of software and hardware, for example in a rider assistance system.

The present invention also provides a control unit for a motorcycle, the control unit being configured to carry out, control, or implement the steps of a variant of the method presented here in corresponding devices.

According to an example embodiment of the present invention, the control unit can be an electrical device with at least one computing unit for processing signals or data, at least one memory unit for storing signals or data, and at least one interface and/or one communication interface for reading in or outputting data embedded in a communication protocol. The computing unit may, for example, be a signal processor, a so-called system ASIC, or a microcontroller for processing sensor signals and outputting data signals depending on the sensor signals. The memory unit may be a flash memory, an EEPROM, or a magnetic memory unit, for example. The interface may be designed as a sensor interface for reading in the sensor signals from a sensor and/or as an actuator interface for outputting the data signals and/or control signals to an actuator. The communication interface may be designed to read in or output the data wirelessly and/or by wire. The interfaces may also be software modules that are present, for example, in a microcontroller in addition to other software modules.

Also advantageous is a computer program product or computer program with program code which can be stored on a machine-readable carrier or storage medium, e.g., a semi-conductor memory, a hard disk memory, or an optical memory and which is used to perform, implement and/or control the steps of the method according to one of the embodiments of the present invention described above, in particular if the program product or program is executed on a computer or a device.

It should be noted that some of the possible features and advantages of the present invention are described here with reference to different embodiments. A person skilled in the art recognizes that the features of the control unit and the method can be suitably combined, adapted, or interchanged to arrive at further embodiments of the present invention.

### BRIEF DESCRIPTION OF THE DRAWINGS

Embodiments of the present invention are described in the following with reference to the figures, wherein neither the figures nor the description are to be construed as limiting the present invention.

FIG. 1 shows a representation of a sequence of a braking operation of a motorcycle using a braking support method according to an exemplary embodiment of the present invention.

This figure is merely schematic and not to scale. Identical reference signs denote identical or functionally identical features.

### DETAILED DESCRIPTION OF EXAMPLE EMBODIMENTS

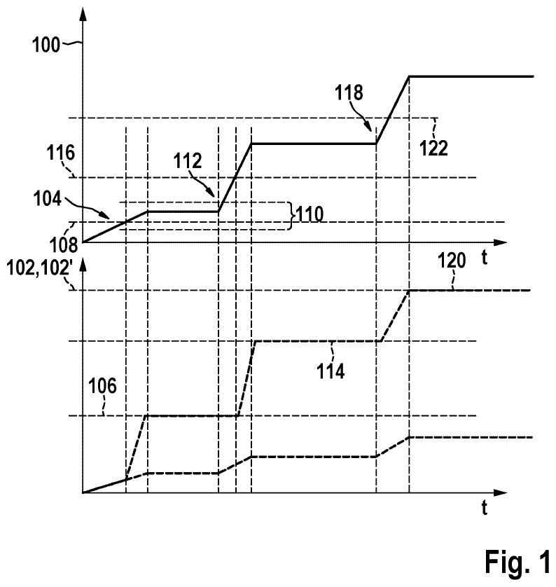

FIG. 1 shows a representation of a sequence of a braking operation in a motorcycle using a braking support method according to an embodiment example. The braking operation is shown in two temporally correlated graphs, in each of which the time t is plotted on the abscissa of the graph. In the first graph, a brake pressure 100 pressed by a rider of the motorcycle at a brake operating element of the motorcycle is plotted on the ordinate of the graph. In the second graph, a deceleration demand 102 or a resulting deceleration 102′ or a resulting pressure at the brake caliper is plotted on the ordinate of the graph.

At t=0, a collision hazard is detected by a sensor system of the motorcycle. The rider has also recognized the collision hazard here and actuates, approximately at time t=0, at least one brake operating element of the motorcycle in order to signal a braking request 104. It is irrelevant whether the rider actuates a brake lever on the handlebars or a brake pedal on the footrest. What is relevant is that the rider generates brake pressure 100. When the braking request 104 is detected, the deceleration demand 102 is increased to a first deceleration value 106 by the method presented here. The first deceleration value 106 is predefined but can be parameterized, and thus it can be tuned to the particular motorcycle and/or the particular rider.

In an embodiment example, the braking request 104 is detected when the brake pressure 100 exceeds a threshold value 108. The first threshold value 108 is predefined but can be parameterized, and thus it can be tuned to the particular motorcycle and/or the particular rider.

In an embodiment example, the braking request 104 is detected when the brake pressure 100 is constant within a predefined hysteresis range 110 or increases. The first hysteresis range 110 is predefined but can be parameterized, and thus it can be tuned to the particular motorcycle and/or the particular rider. In particular, the hysteresis range 110 has an upper value and a lower value. The brake pressure 100 may swing between the two values, and then the braking request 104 is detected. The braking request 104 is also further detected when the brake pressure 100 rises above the upper value.

The motorcycle is now decelerated with greater deceleration 102′ than would have been achieved only by means of the brake pressure 100 at the brake operating element.

The rider then recognizes here that the situation is hazardous, i.e., the previous braking is not sufficient, or may become more hazardous, and the rider demands more deceleration 102′, i.e., presses further. This further squeezing 112 signals that the rider is definitely attentive. When the further squeezing 112 is detected, the deceleration demand 102 is increased to a second deceleration value 114. The second deceleration value 114 is likewise predefined but can be parameterized, and thus it can also be tuned to the particular motorcycle and/or the particular rider.

In the further squeezing 112, the rider generates more brake pressure 100 at the brake operating element. In an embodiment example, the further squeezing 112 is detected when the brake pressure 100 exceeds a further-squeezing value 116. When the further-squeezing value 116 is exceeded, the deceleration demand 102 is increased to the second deceleration value 114. The further-squeezing value 116 is predefined but can be parameterized, and thus it can also be tuned to the particular motorcycle and/or the particular rider.

The motorcycle is now decelerated with significantly greater deceleration 102′ than the rider would achieve via his pressed brake pressure 100.

In an embodiment example, the previous deceleration 102′ has not yet decelerated the motorcycle intensely enough. The rider wants to decelerate the motorcycle even more intensely and presses further again. When the second further squeezing 118 is detected, the deceleration demand 102 is increased to a third deceleration value 120. The third deceleration value 120 is again higher than the second deceleration value 114. The third deceleration value 120 may be above an activation threshold of an ABS of the motorcycle, depending on ambient conditions. The ABS then intervenes to limit the actual deceleration 102.

In an embodiment example, the second further squeezing 118 is detected when the brake pressure 100 is greater than a second further-squeezing value 122. The second further squeezing 118 causes the brake pressure 100 to rise again, because in the second further squeezing 118 the rider again generates more brake pressure 100 by increased hand force or pedal force. The second further-squeezing value 122 is predefined but can be parameterized, and thus it can also be tuned to the particular motorcycle and/or the particular rider.

In an embodiment example, the deceleration demand 102 is increased proportionally to the brake pressure 100 during the second further squeezing 118. The deceleration demand 102 is, for example, higher by a predefined increase factor than the deceleration 102′ actually achieved by the brake pressure 100. This proportional further increase in the deceleration demand 102 allows the rider to directly control the deceleration 102′ via the brake pressure 100 at the brake operating element and thus also to remain below the activation threshold of the ABS. If the brake pressure 100 is increased above the activation threshold, the ABS intervenes here too and, by means of its interventions, limits the actual deceleration 102′.

Possible embodiments of the present invention are summarized again below or presented with a slightly different choice of words.

A new control strategy for the emergency brake assist function is presented.

In the passenger car sector, emergency brake assists are already in series production and have established themselves. In motorcycle development, these systems are currently still in the study phase and pre-development phase. A precursor to these emergency brake assists are brake supporters which, in detected hazardous situations (detection via radar), build up additional brake pressure in the ABS system if the rider does not build up enough pressure to be able to reduce the differential speed. For this purpose, with a clearly detectable braking request from the rider (minimum value for brake pressure is reached) and detection of a hazardous situation by the radar, there are two conditions. These systems may also be referred to as brake boost assist (BBA) or emergency brake assist (EBA).

Since the brake pressure can be increased to the ABS control range in the four-wheeled vehicle sector due to sufficient stability, no critical situations are expected in the passenger car sector. Since, however, a two-wheeled vehicle is basically unstable, a conventional emergency brake assist/automated emergency brake (AEB) cannot be implemented one to one. Studies have shown that, in automatic braking interventions, certain pressure levels, including jerk limiting, must not be exceeded, in order to ensure a safe state of the two-wheeled drive including the rider. However, these values apply only to inattentive drivers.

In the approach presented here, the conventional control strategy of the emergency brake assist (EBA) function is adapted. Traditionally, a maximum deceleration is allowed, which is parameterizable and is designed for the inattentive rider.

This limit value is constant and is easily reached in critical situations. Greater deceleration is thus conventionally not allowed.

If, however, in a hazardous situation a clear rider's request is detected (sufficient brake pressure at the master cylinder), it can be assumed that the rider is attentive and is prepared for the vehicle deceleration. In this case, pressure can also be built up to ABS control. This would then correspond to the maximum possible deceleration.

In the event of false-positive emergency brake assist (EBA) interventions, it may be that hazardous situations arise with the traffic behind (rear-end collision). Therefore, it is advantageous if the maximum allowable deceleration is limited during normal travel. In special circumstances, this limit is lifted in the approach presented here. The special circumstances comprise detecting that the rider is attentive and that a collision with the vehicle in front is inevitable.

The attentiveness detection or rider braking detection is accomplished via the rider pressure (p_vor), i.e., the brake pressure measurable at the master cylinder. If the rider pressure (p_vor) is constant within a hysteresis, then an attentive rider can be assumed. This means that the braking is intended. If the rider squeezes further and the rider pressure (p_vor) increases, it can likewise be assumed that the rider is attentive and the braking is intended.

In the approach presented here, the maximum possible deceleration in the ABS is raised when the radar demands the maximum deceleration (on CAN bus to ABS), when the emergency brake assist (EBA) is activated (first trigger threshold was reached by rider pressure), and when the attentiveness detection (rider braking detection) detects attentiveness.

When the minimum pressure (p_vor) and a minimum deceleration of the vehicle (a_ist) (both are parameters) are reached, the maximum possible deceleration is raised by the system (parameter). In this case, it is assumed that the deceleration is desired and necessary and that there is no false detection by the environmental sensing system. The first pressure threshold_EBA, the first maximum possible deceleration for the first pressure threshold, the second pressure threshold_EBA and the deceleration offset which is added to the deceleration corresponding to the rider's braking request are parameterizable.

If, during the braking intervention by the emergency brake assist EBA (ABS builds up additional pressure in the brake caliper), p_vor is further increased, then in an embodiment example the maximum possible deceleration is raised further in a factorized way. The first pressure threshold_EBA, the first maximum possible deceleration for the first pressure threshold, the second pressure threshold_EBA, and the factor for the new max. possible deceleration are parameterizable depending on p_vor.

Lastly, it should be noted that terms such as “having,” “comprising,” etc. do not exclude other elements or steps and terms such as “one” or “a” do not exclude a plurality.

1-10. (canceled)

11. A braking support method for a motorcycle, the method comprising the following steps:
increasing, in response to detection of a collision hazard for the motorcycle using a sensor system of the motorcycle and detection of a braking request from a rider of the motorcycle, a deceleration demand for a brake system of the motorcycle to a predefined first deceleration value; and
increasing, in response to detection of a subsequent further squeezing by the rider, the deceleration demand to a predefined second deceleration value.

12. The braking support method according to claim 11, wherein the braking request is detected when a brake pressure demanded via at least one brake operating element of the motorcycle is greater than a threshold value.

13. The braking support method according to claim 12, wherein the braking request is detected when the brake pressure is constant within a predefined hysteresis range or the brake pressure increases.

14. The braking support method according to claim 11, wherein the further squeezing is detected when the demanded brake pressure is greater than a predefined further-squeezing value.

15. The braking support method according to claim 11, wherein, in response to detection of a subsequent second further squeezing, the deceleration demand is increased to a third deceleration value.

16. The braking support method according to claim 15, wherein the third deceleration value is set using the demanded brake pressure during the second further squeezing and a predefined increase factor.

17. The braking support method according to claim 15, wherein the second further squeezing is detected when the demanded brake pressure is greater than a predefined second further-squeezing value.

18. A control unit for a motorcycle, the control unit being configured to carry out, implement and/or control a braking support method, comprising:
increasing, in response to detection of a collision hazard for the motorcycle using a sensor system of the motorcycle and detection of a braking request from a rider of the motorcycle, a deceleration demand for a brake system of the motorcycle to a predefined first deceleration value; and
increasing, in response to detection of a subsequent further squeezing by the rider, the deceleration demand to a predefined second deceleration value.

19. A machine-readable storage medium on which is stored a computer program for providing braking support for a motorcycle, the computer program, when executed by a processor, causing the processor to perform the following steps:
increasing, in response to detection of a collision hazard for the motorcycle using a sensor system of the motorcycle and detection of a braking request from a rider of the motorcycle, a deceleration demand for a brake system of the motorcycle to a predefined first deceleration value; and
increasing, in response to detection of a subsequent further squeezing by the rider, the deceleration demand to a predefined second deceleration value.
